(19) United States
(12) Patent Application Publication
(10) Pub. No.: US 2016/0246211 A1
(43) Pub. Date: Aug. 25, 2016

(54) CONDUCTIVE ROLLER AND METHOD FOR PRODUCING THE SAME

(71) Applicant: SYNZTEC CO., LTD., Tokyo (JP)

(72) Inventors: Hirokazu HAMADA, Kanagawa (JP); Lei WANG, Kanagawa (JP)

(21) Appl. No.: 15/050,888

(22) Filed: Feb. 23, 2016

(30) Foreign Application Priority Data
Feb. 25, 2015 (JP) 2015-035713

(51) Int. Cl. G03G 15/08; B05D 5/12; F16C 13/00

(52) U.S. Cl. CPC G03G 15/0808

(57) ABSTRACT

To provide a conductive roller which can attain a desired conductivity and low compression set and which can suppress production material cost. A conductive roller having a core and a conductive elastic layer disposed on the core, wherein the conductive elastic layer is formed of a vulcanized product of a rubber blend base containing NBR and ECO with a peroxide vulcanizing agent; the NBR is a low-nitrile type rubber having an acrylonitrile content lower than 25 mass %; and the ratio by mass of NBR to ECO, NBR:ECO, satisfies the following relationship (1): 40:60 to 75:25 . . . (1).

The entire disclosure of Japanese Patent Application No. 2015-035713 filed on Feb. 25, 2015 is expressly incorporated by reference herein.

### BACKGROUND OF THE INVENTION

1. Field of the Invention

The present invention relates to an electrically conductive roller (hereinafter referred to simply as “conductive roller”) and to a method for producing the roller.

2. Background of the Invention

Hitherto, image-forming apparatuses such as electrophotographic copying machines and printers and toner-jet copying machines and printers have employed various types of conductive rollers. For example, Patent document 1 discloses a development conductive roller as such a conductive roller.

Such a conductive roller has a core, and an electrically conductive elastic layer (hereinafter referred to simply as “conductive elastic layer”) provided on the core. Such conductive rollers are required to have a conductive elastic layer having a moderate level of electrical resistance (i.e., a desired conductivity) and to exhibit a considerable restoration property force after compressive deformation (i.e., low compression set) and other characteristics.
Patent document 1: Japanese Patent Application Laid-Open (kokai) No. 2010-160285

However, such conventional conductive rollers problematically encounter difficulties in attaining a desired conductivity and low compression set, and also in suppressing material cost. More specifically, when a low-resistivity polymer, which is generally expensive, is used singly as a rubber base material so as to realize a target conductivity, difficulty is encountered in maintaining reasonable product cost. When a polymer blend containing a plurality of polymers is used as a rubber base material, the formed conductive elastic layer tends to exhibit impaired compression set.

In addition to development rollers, these problems are also involved in other conductive rollers (e.g., charge-imparting rollers, transfer rollers, and toner-feeding rollers), which are employed in image-forming apparatuses. Also, in addition to conductive rollers employed in image-forming apparatuses, the problem is involved in conductive rollers (such as a cleaning roller) disposed in a card insertion slat of a banking terminal or the like.

Thus, an object of the present invention is to provide a conductive roller which can attain a desired conductivity and low compression set and which can suppress production material cost. Another object is to provide a method for producing the conductive roller.

### SUMMARY OF THE INVENTION

In one aspect of the present invention for solving the aforementioned problems, there is provided a conductive roller having a core and a conductive elastic layer disposed on the core, wherein

the conductive elastic layer is formed of a vulcanized product of a rubber blend base containing a nitrile rubber (NBR) and an epichlorohydrin rubber (ECO) with a peroxide vulcanizing agent;

the NBR is a low-nitrile type rubber having an acrylonitrile content lower than 25 mass %; and

the ratio by mass of NBR to ECO, NBR:ECO, satisfies the following relationship (1):

40:50 to 75:25 (1).

Preferably, the peroxide vulcanizing agent content to 6 parts by mass, with respect to 100 parts by mass of the rubber blend base.

Preferably, the conductive roller is employed as a development roller of an image-forming apparatus.

Preferably, the conductive elastic layer has a compression set of 3.7% or lower and an electrical resistance of 1×10⁶ to 5×10⁷Ω.

In another aspect of the present invention, there is provided a method for producing a conductive roller, which has a core and a conductive elastic layer disposed on the core, wherein the method comprises forming the conductive elastic layer by vulcanizing a rubber blend base containing a nitrile rubber (NBR) and an epichlorohydrin rubber (ECO) with a peroxide vulcanizing agent, the NBR being a low-nitrile type rubber having an acrylonitrile content lower than 25 mass %, and the ratio by mass of NBR to ECO, NBR:ECO, satisfying the following relationship (1)

40:60 to 75:25 (1).

According to the conductive roller and the production method thereof, a target conductivity and low compression set can be realized, and production material cost can be suppressed.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a schematic view of an image-forming apparatus employing a conductive roller of Embodiment 1;

FIG. 2A is a schematic view of an example of the configuration of the conductive roller of Embodiment 1;

FIG. 2B is another schematic view of the example of the configuration of the conductive roller of Embodiment 1;

FIG. 2C is another schematic view of the example of the configuration of the conductive roller of Embodiment 1;

FIG. 3A is a schematic view of a variation of the configuration the conductive roller of Embodiment 1;

FIG. 3B is a schematic view of another variation of the configuration the conductive roller of Embodiment 1;

FIG. 4 is a sketch for illustrating an electrical resistance measurement procedure;

FIG. 5A is a graph showing the results of Test Examples 1 to 3;

FIG. 5B is a graph showing the results of Test Examples 1 to 3;

FIG. 5C is a graph showing the results of Test Examples 1 to 3;

FIG. 5D is a graph showing the results of Test Examples 1 to 3;

FIG. 6A is a graph showing the results of Test Examples 4 to 6;

FIG. 6B is a graph showing the results of Test Examples 4 to 6;

FIG. 6C is a graph showing the results of Test Examples 4 to 6;

FIG. 7A is a graph showing the results of Test Examples 7 to 9;

FIG. 7B is a graph showing the results of Test Examples 7 to 9;

FIG. 7C is a graph showing the results of Test Examples 7 to 9; and

FIG. 8 is a graph showing the results of Test Example 10.

### DETAILED DESCRIPTION OF PREFERRED EMBODIMENTS

Hereinafter, with reference to the attached drawings, embodiments of the present invention will next be described. However, such embodiments are given for illustration purpose, and in the following description for illustrating the present invention, any modification can be made within the scope of the present invention. The same reference numerals as employed in the drawings denote the same members, and overlapping descriptions will be omitted, if required.

### Embodiment 1

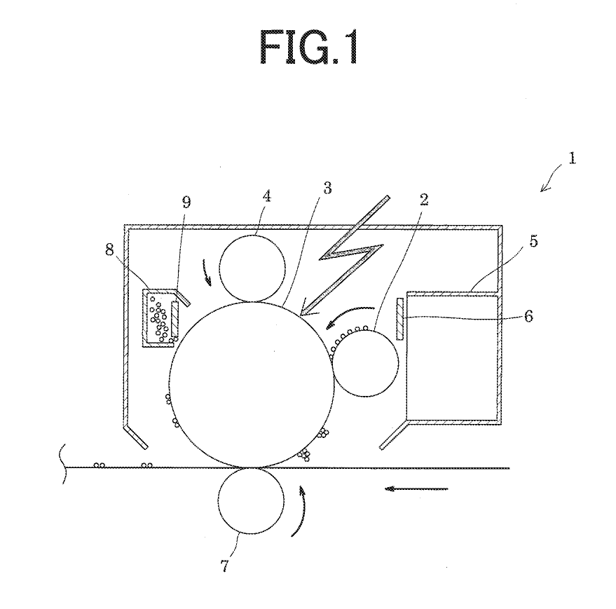

FIG. 1 is a schematic view of the configuration of an image-forming apparatus employing a conductive roller of Embodiment 1. An image-forming apparatus 1 employs a development roller 2 serving as the conductive roller of the embodiment.

As shown in FIG. 1, the image-forming apparatus 1 has a charge-imparting member (e.g., a charge-imparting roller 4) for charging a photoreceptor 3; a light-exposure member for exposing the charged photoreceptor 3 to thereby form a latent image; development members (e.g., a development roller 2, a development blade 6, and a toner-supply roller) for tribologically charging a toner in a toner box 5 and conveying the toner to the photoreceptor 3; transfer members (e.g., a transfer roller 7 and a transfer belt) for transferring; the toner fed onto the photoreceptor 3 to a paper sheet; and

a cleaning member (e.g., a cleaning blade 9) for scraping the toner remaining on the photoreceptor 3 into a waste toner box 8.

The development roller 2 is required to have a conductivity of interest for suppressing migration of toner and other reasons. The development roller 2 remains in a contact state with the photoreceptor 3, the development blade 6, and the like. Thus, when a conductive elastic layer of the development roller 2 undergoes compression set, variation in charging characteristic and the like occurs, resulting in impairment in quality of printed images. As described hereinbelow, the conductive roller of Embodiment 1 attains a conductivity of interest and low compression set, and material cost can be reduced. Therefore, through employment of the conductive roller of Embodiment 1 as the development roller 2, the image-forming apparatus 1 attains excellent characteristics (including printing performance), and reduction in material cost.

In one case, the development roller 2, the photoreceptor 3, the toner box 5, and the like are built in the housing of the image-forming apparatus 1 in a detachable manner, to realize a cartridge mode. In this case, through employment of the conductive roller of Embodiment 1 as the development roller 2, the cartridge-type image-forming apparatus attains excellent characteristics (including printing performance), and reduction in material cost.

In Embodiment 1, the conductive roller of the embodiment is employed as the development roller 2. However, the conductive roller of the present invention is not limited to the development roller 2. Other than the development roller 2, the conductive roller of present invention may also apply to other conductive rollers (e.g., the charge-imparting roller 4, the transfer roller 7, and a toner-supply roller) employed in an image-forming apparatus. The present invention may be applicable not only to a conductive roller employed in an image-forming apparatus, but also to a conductive roller (e.g., a cleaning roller) disposed in, for example, a card insertion slot of teller terminals and ticket machines.

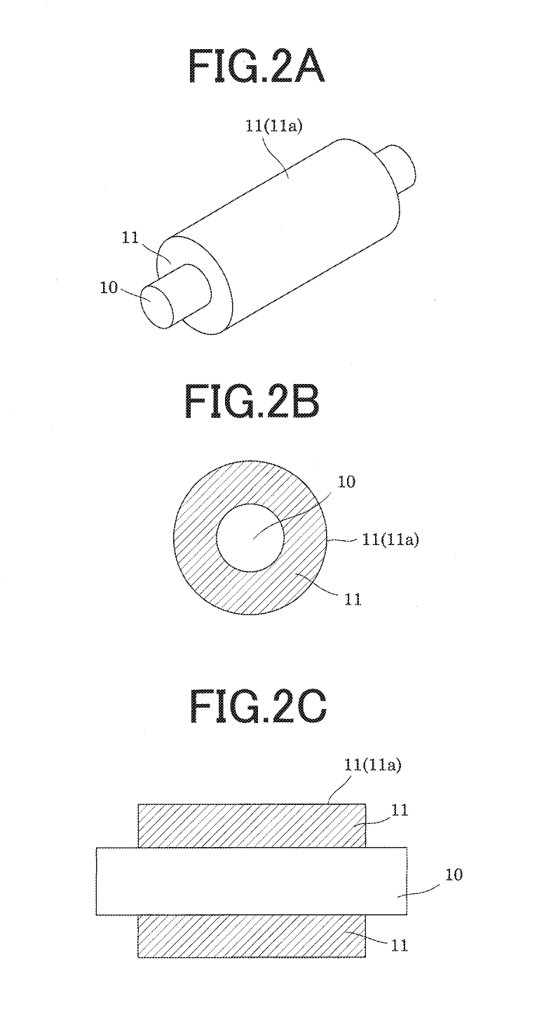

FIGS. 2A to 2C are schematic views of an exemplary configuration of the conductive roller of Embodiment 1. FIG. 2A is a perspective view of the conductive roller. FIG. 2B is a cross-section of the conductive roller, cut along a direction orthogonal to the core axis direction. FIG. 2C is a cross-section of the conductive roller, cut along the core axis direction.

As shown in FIGS. 2A to 2C, the conductive roller of the embodiment has a core 10, and a conductive elastic layer 11 disposed on the core 10. The conductive elastic layer 11 is formed of a vulcanized product of a rubber base containing a nitrile rubber (NBR) and an epichlorohydrin rubber (ECO) with a peroxide vulcanizing agent. Hereinafter, the rubber base may be referred to as a “rubber blend base.” The aforementioned NBR is a low-nitrile type rubber having an acrylonitrile content lower than 25 mass %, and the ratio by mass of NBR to ECO satisfies the following relationship (1):

NBR:ECO=40:60 to 75:25 (1).

The core 10 serves as a rotation axis of the conductive roller. No particular limitation is imposed on the material of the core 10 within the scope the present invention, and either a metallic material or a resin material may be used. No particular limitation is imposed on the shape of the core 10 within the scope the present invention, and the core 10 may or may not be hollow.

The conductive elastic layer 11 is made of a conductive elastic body which is disposed on the core 10. In various image-forming apparatuses, a development roller, a transfer roller, a toner-supply roller, and the like require a conductivity of interest for suppressing migration of toner and other reasons. Also, a charge-imparting roller and the like require a conductivity of interest for controlling charging of the photoreceptor and other reasons. Furthermore, in various teller terminals, a cleaning roller and the like require a conductivity of interest for removing undesired matter deposited on the transported printing object and other reasons. In any of such uses, the conductive elastic layer of the conductive roller is required to have a target conductivity (i.e., a not excessively high electric resistance; e.g., a middle-level resistance).

According to demand of recent years, such apparatuses, cartridges, and the like, in which the conductive roller is to be placed, are desired to have higher performance with smaller dimensions. In any of such uses, the conductive roller is required to exhibit excellent restoration property after compressive deformation (i.e., low compression set).

Accordingly, in Embodiment 1, the conductive elastic layer 11 is formed from a rubber blend base containing a nitrile rubber (NBR) of low-nitrile type and an epichlorohydrin rubber (ECO) through vulcanization of the base with a peroxide vulcanizing agent. Among polymers used in such a rubber base, NBR has high resistivity and is inexpensive. In contrast, ECO is more expensive than NBR but has low resistivity. The rubber blend base which formed the conductive elastic layer 11 of Embodiment 1 is formed of a blend of such NBR and ECO.

Conventionally, when a polymer blend of a plurality of polymers is used as a rubber base, compression set tends to be impaired. In order to solve this problem, in Embodiment 1, a peroxide vulcanizing agent is added to a blend NBR and ECO having a specific blend ratio by mass. As a result, the thus-obtained conductive elastic layer 11 exhibits low compression set, although the elastic layer 11 is formed from a polymer blend as a rubber base. Conventionally, such a conductive elastic layer is formed as a sulfur-vulcanized system. However, the conductive elastic layer 11 of Embodiment 1 is formed as a peroxide-vulcanized system.

That is, Embodiment 1 is based on the following finding. More specifically, in Embodiment 1, an NBR having a specific nitrile content is selected, as a rubber base, from among high-resistance and inexpensive polymers (NBRs), and a low-resistance polymer (ECO) is incorporated at a specific ratio into the rubber base, to thereby suppress the electric resistance of the conductive elastic layer 11 to a middle level. Then, through incorporating a peroxide vulcanizing agent into the rubber blend base and subsequent vulcanization, a low compression set of the formed conductive elastic layer 11 is realized to such an extent that a conventional sulfur-vulcanized polymer blend cannot attain. In addition, material cost of Embodiment 1 can be suppressed, as compared with the case where only an expensive and low-resistance polymer is used.

Meanwhile, in some cases, the conductivity of an elastic body is adjusted through addition of a conductivity-imparting agent (carbon black). However, carbon black has a large effect of varying (increasing or decreasing) the resistivity of a rubber base commensurate with the amount addition, particularly in a middle-resistance region of the rubber base. Thus, by use of only carbon black, difficulty is encountered in tuning the electric resistance of an elastic body, and moreover, in suppressing the electric resistance to a middle level. In contrast, in Embodiment 1, the electric resistance of the conductive elastic layer 11 can be readily modified through tuning of the mass ratio of NBR to ECO, whereby the electric resistance can be readily suppressed to a middle level.

The electric resistance of the conductive elastic layer 11 may increase due to incorporation of a peroxide vulcanizing agent. However, in Embodiment 1, the type of NBR (i.e., nitrile type) and the mass ratio of NBR to ECO are predetermined in consideration of the aforementioned increase. In the case where the increase in electric resistance due to the peroxide vulcanizing agent is small, or even in the case where the increase in electric resistance is significant, appropriate tuning of the type of NBR (i.e., nitrile type) and the mass ratio of NBR to ECO leads to suppression of the electric resistance of the conductive elastic layer 11 to a middle level.

The ratio by mass of NBR to ECO satisfies the aforementioned relationship (1). In Embodiment 1, although the conductive elastic layer formed from a peroxide-vulcanized system receives the effect of the peroxide vulcanizing agent, the electric resistance of the conductive elastic layer can be suppressed to a middle level, since the aforementioned relationship (1) is satisfied. The aforementioned relationship (1) is predetermined such that both a target conductivity and low compression set can be attained, and material cost can be suppressed.

When the NBR content is excessively high (i.e., the ECO content is excessively low), the electric resistance of the conductive elastic layer rises to such an extent that the conductive roller cannot be employed in specific applications (e.g., a development roller). In contrast, when the NBR content is excessively low (i.e., the ECO content is excessively high), a low-cost advantage fails to be attained, even as compared with the case where only a low-resistance polymer is used.

NBR is a copolymer of acrylonitrile and 1,3-butadiene. NBR is generally categorized, based on the acrylonitrile content, to NBR of a low-nitrile type (acrylonitrile content: lower than 25 mass %), NBR of a medium-nitrile type (acrylonitrile content: 25 mass % to 35 mass %), and NBR of a high-nitrile type (acrylonitrile content: higher than 35 mass %).

The NBR used in Embodiment 1 is of a low-nitrile type. Only when the NBR satisfying the aforementioned relationship (1) is of a low-nitrile type, the formed conductive elastic layer 11 exhibits low compression set. When a plurality of NBRs used in Embodiment 1 are all of a low-nitrile type, the conductive elastic layer 11 can more readily exhibit low compression set.

However, within the scope of the present invention, a small amount of an NBR of a medium-nitrile type or an NBR of a high-nitrile type may be added to the NBR of a low-nitrile type. In this case, when an NBR less expensive than the low-nitrile type NBR is added, material cost can be reduced. Notably, such a medium-nitrile type NBR and a high-nitrile type NBR are included in NBRs satisfying the aforementioned relationship (1).

NBRs may be used singly or in combination of two or more species. Commercial products of NBR may also be used. Examples of such commercial NBRs (low-nitrile type NBRs) include Nipol 401, Nipol 401LL, and Nipol DN401L (products of Zeon Corporation) and JSR N250S, N260S, and N250SL (products of JSR Corporation).

ECO is a copolymer formed from epichlorohydrin and ethylene oxide. ECO is more expensive than NBR, but has lower resistivity. As described above, a high-resistance, inexpensive polymer (NBR) is used as a rubber base, and a low-resistance polymer (ECO) is added in a specific amount to the rubber base, to thereby suppress the electric resistance of the conductive elastic layer 11 to a middle level.

ECOs may be used singly or in combination of two or more species. Commercial products of ECO may also be used. Examples of such commercial ECOs include Epion 301, Epichlomer CG, and Epichlomer DG (products of Daiso Chemical Co., Ltd.) and Hydrin 3106 and Hydrin 3108 (products of Zeon Corporation).

Within the scope of the present invention, an additional polymer other than NBR and ECO may be added to the rubber blend base. No particular limitation is imposed on the additional polymer, and examples include polyurethane, styrene rubber, and chloroprene rubber. Even in the case of addition of an additional polymer, 90 mass % or more of the rubber blend base is preferably composed of NBR and ECO. Needless to say, the rubber blend base is preferably formed from only NBR and ECO.

The peroxide vulcanizing agent is an organic peroxide vulcanizing agent for accelerating cross-linking reaction of the rubber blend base. No particular limitation, is imposed on the peroxide vulcanizing agent. Examples of the peroxide vulcanizing agent include dibutyl peroxide, tert-butyl cumyl peroxide, 2,5-dimethyl-2,5-dihexane, 2,5-dimethyl-2,5-dihexyne-3, 1,3-bis(tert-butylperoxyisopropyl)benzene, 1,1-bis(tert-butylperoxy)-3,3,5-trimethylcyclohexane, n-butyl-4,4-bis(tert-butylperoxy) valerate, tert-butyl peroxybenzoate, tert-butyl peroxyisopropylcarbonate, and dicumyl peroxide.

The peroxide vulcanizing agents may be used singly or in combination of two or more species. Commercial products of the peroxide vulcanizing agent may be used. Examples of such products include Percumyl D-40 and Perbutyl P-40 (products of NOF Corporation).

The peroxide vulcanizing agent content is preferably 2 to 6 parts by mass, with respect to 100 parts by mass of the rubber blend base. When the peroxide vulcanizing agent content is excessively low, the electric resistance of the conductive elastic layer tends to rise. Also, when the peroxide vulcanizing agent content is excessively low, difficulty is encountered in attaining mechanical strength required in accordance with the use and the like of the conductive roller. In contrast, when the peroxide vulcanizing agent content is excessively high, durability of the conductive elastic layer tends to be reduced. Also, when the peroxide vulcanizing agent content is excessively high, hardness of the conductive elastic layer tends to rise. When the hardness of the conductive elastic layer increases, conveyance performance of an object to be conveyed tends to lower, in a certain use and the like of the conductive roller.

The electric resistance and hardness of the conductive elastic layer vary not only by the peroxide vulcanizing agent content but also by the species of the peroxide vulcanizing agent. When the peroxide vulcanizing agent content falls within the range (2 to 6 parts by mass), even by use of any species of the peroxide vulcanizing agent, an excessive increase in electric resistance and hardness can be avoided.

As described above, the electric resistance of the conductive elastic layer 11 may increase due to addition of the peroxide vulcanizing agent. The amount of increase varies depending upon the species of the peroxide vulcanizing agent used. Thus, the peroxide vulcanizing agent content may be appropriately predetermined to a preferred value from the range (2 to 6 parts by mass), in accordance with the type of the peroxide vulcanizing agent used.

To the aforementioned rubber blend base or peroxide vulcanizing agent, an additional material may be added, if required. No particular limitation is imposed on the additional material, and examples include a processing aid, a vulcanization accelerator, an antioxidant, carbon black, and calcium carbonate (CaCO₃). Commercial products thereof may also be used.

For example, if required, a processing aid may be added to the rubber blend base or the peroxide vulcanizing agent in order to improve processing characteristics (e.g., rubber kneading property). In one specific mode, an optional internal releasing agent (e.g., an internal releasing agent containing fatty acid), which is a type of processing aid, is added to the rubber blend base or peroxide vulcanizing agent. Such processing aids may be used singly or in combination of two or more species. Alternatively, zinc oxide may be added as a vulcanization accelerator.

Alternatively, in order to prevent aging of the conductive elastic layer 11, an additional antioxidant may be added to the aforementioned rubber blend base or peroxide vulcanizing agent. In one mode, a phenolic antioxidant is added to the rubber blend base or peroxide vulcanizing agent. Such antioxidants may be used singly or in combination of two or more species. Alternatively, in order to regulate the conductivity of the conductive elastic layer 11, carbon black may be added in accordance with need. The carbon black products may be used singly or in combination of two or more species.

The additional material is preferably added in an amount of about 50 parts by mass or less, with respect to 100 parts by mass of the rubber blend base. However, in the case where such additional materials are less expensive than the aforementioned NBR, ECO, or peroxide vulcanizing agent, material cost of the conductive roller can be suppressed when large amounts of such materials are contained. Examples of such inexpensive material include calcium carbonate (CaCO₃) In other words, within the scope of the present invention, among such additional materials, an expensive material is preferably not used, from the viewpoint of material cost.

Needless to say, addition of these additional materials to the rubber blend base or peroxide vulcanizing agent may be omitted. In one possible mode, the conductive elastic layer is formed without adding an antioxidant. Through use of no antioxidant, hardness of the conductive elastic layer conceivably decreases. However, in such a case, both a target conductivity and low compression set can be attained. Even when no antioxidant is used, the vulcanization time is substantially unchanged.

Alternatively, the conductive elastic layer may be formed with no addition of carbon black. By virtue of omission of addition of carbon black, conceivably, the commercial value of the conductive elastic layer increases; the hardness of the conductive elastic layer decreases; and the surface roughness of the conductive elastic layer increases. However, in such a case, both a target conductivity and low compression set can be attained.

Alternatively, the conductive elastic layer may be formed by adding no zinc oxide serving as a vulcanization accelerator. By virtue of omission of addition of zinc oxide, under conceivable situations, the hardness of the conductive elastic layer decreases, the surface roughness of the conductive elastic layer is impaired, and rubber life is impaired. However, in such a case, both a target conductivity and low compression set can be attained. Even when no zinc oxide is added, no substantial effect is imposed on the vulcanization performance. If the zinc oxide amount is reduced, it is preferred that the production cost should be suppressed by use of a more inexpensive filler.

Through vulcanization of the aforementioned rubber blend base by use of a peroxide vulcanizing agent and subsequent curing, the conductive elastic layer 11 can be formed. No particular limitation is imposed on the method for forming the conductive elastic layer 11, and injection molding, extrusion, and other techniques may be employed.

A surface portion 11a of the conductive elastic layer 11 may be polished. Alternatively, the surface portion 11a of the conductive elastic layer 11 may be provided with a surface treatment layer or a coating layer. In such a case, the surface treatment layer or the coating layer is preferably formed such that both a target conductivity and low compression set can be attained, and material cost can be suppressed.

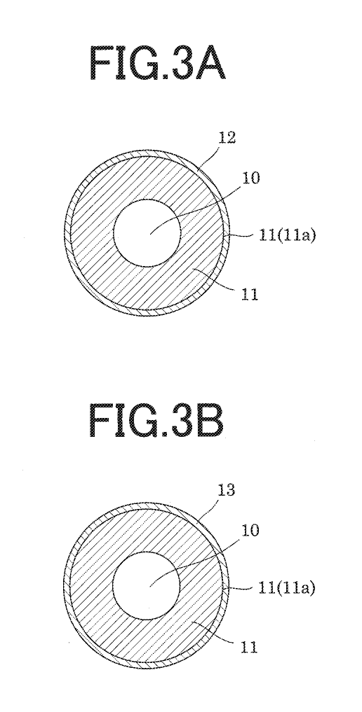

FIGS. 3A and 3B are schematic views of variations of the conductive roller of Embodiment 1. FIG. 3A shows an example in which a surface treatment layer 12 is disposed on the surface portion 11a of the conductive elastic layer 11, while FIG. 3B shows an example in which a coating layer 13 is disposed on the surface portion 11a of the conductive elastic layer 11.

The surface treatment layer 12 may be provided through, for example, an impregnation or spray coating technique. In the case of impregnation, the conductive elastic layer 11 is impregnated with a surface treatment liquid at least containing an isocyanate compound and an organic solvent. After completion of impregnation of the conductive elastic layer 11 with the surface treatment liquid, the organic solvent is removed, and the components including the isocyanate compound are cured. In the case of spray coating, the surface treatment liquid is applied onto the conductive elastic layer 11, and the liquid is dried for curing.

The isocyanate compound reacts with the rubber blend base or the like for forming the conductive elastic layer 11, and the formed cross-linking structure is provided inside the conductive elastic layer 11. Such a surface treatment liquid is incorporated into the surface portion 11a of the conductive elastic layer 11 via application and impregnation, to thereby form the surface treatment layer 12. The surface treatment layer 12 is formed integrally with the conductive elastic layer 11 such that the isocyanate component density gradually decreases from the surface of the layer to the inside of the surface portion. Through provision of the surface treatment layer 12, wear resistance and other properties of the conductive elastic layer 11 can be enhanced, as compared with that of the conductive elastic layer 11 before provision of the surface treatment layer 12.

Examples of the isocyanate component contained in the surface treatment liquid include isocyanate compounds such as 2,6-tolylene diisocyanate (TDI), 4,4′-diphenylmethane diisocyanate (MDI), p-phenylene diisocyanate (PPDI), 1,5-naphthalene diisocyanate (NDI), and 3,3′-dimethyldiphenyl-4,4′-diisocyanate (TODI), and oligomers and modified products thereof. Examples also include a prepolymer formed from a polyol and an isocyanate.

The surface treatment liquid may further contain a polymer selected from among a polyether polymer, a fluoroacrylic polymer, and an acrylic silicone polymer. Also, any of the aforementioned additional materials may be added to the surface treatment liquid.

The surface treatment liquid contains an organic solvent which can dissolve the aforementioned isocyanate component and any of the aforementioned additional compounds. No particular limitation is imposed on the organic solvent, and examples of the organic solvent which may be used in the invention include ethyl acetate, methyl ethyl ketone (MEK), and toluene.

In one procedure of forming the coating layer 13 on the surface portion 11a of the conductive elastic layer 11, a coating agent is applied onto the conductive elastic layer 11, and the coating agent is dried for curing. The coating agent which may be used in the invention may be an agent containing urethane, urethane acrylate, nylon, or the like. No particular limitation is imposed on the method of applying the coating agent. Examples of the coating method include dip coating, coating with a rubber roller, and spray coating.

As described hereinabove, the conductive roller of Embodiment 1 can provide a conductivity of interest and low compression set, and material cost can be reduced. The conductive roller of Embodiment 1 can serve as a conductive roller (e.g., a charge-imparting roller, a development roller, a transfer roller, and a toner-feeding roller) employed in, for example, image-forming apparatuses such as electrophotographic copying machines and printers and toner-jet copying machines and printers. In addition, the conductive roller of Embodiment 1 may also serve as a conductive roller (such as a cleaning roller) disposed in a card insertion slot of teller terminals and ticket machines.

The conductive roller of Embodiment 1 can be produced by vulcanizing a rubber blend base with a peroxide vulcanizing agent, the rubber blend base containing NBR and ECO with a ratio by mass of NBR to ECO satisfying the aforementioned relationship (1), and the NBR being of a low-nitrile type with an acrylonitrile content lower than 25 mass. Other than these conditions, a conventional production method may be applied.

### EXAMPLES

The present invention will next be described in more detail by way of examples, which should not be construed as limiting the invention thereto.

### <Evaluation 1>

Characteristics of conductive rollers were assessed under varied ratios by mass of NBR to ECO.

### Example 1

NBR (Nipol DN401L, product of Zeon Corporation) (80 parts by mass), ECO (Epion 301, product of Daiso Chemical Co., Ltd.) (20 parts by mass), a processing aid (stearic acid) (0.5 parts by mass), a vulcanization accelerator (zinc oxide) (5 parts by mass), an antioxidant (BET; 3,5-di-t-butyl-4-methylphenol) (0.8 parts by mass), carbon black (Seast GSO, product of Tokai Carbon Co., Ltd.) (10 parts by mass), carbon black (MT Carbon) (10 parts by mass), and a peroxide vulcanizing agent (Percumyl D-40, product of NOF Corporation) (5 parts by mass) were kneaded by means of a roller mixer, and the kneaded product was extruded into a shaft (a core). The thus-formed shaft was vulcanized at 180° C. for 15 minutes, to thereby yield a conductive roller of Example 1.

### Examples 1a to 4

The procedure of Example 1 was repeated, except that the ratio by mass of NBR to ECO was changed within a range (NBR ECO=40:60 to 75:25) shown in TABLE 1, to thereby yield conductive rollers of Examples 1a to 4.

### Comparative Example 1

The procedure of Example 1 was repeated, except that the ratio by mass of NBR to ECO was changed to fall outside a range (NBR ECO=40:60 to 75:25) shown in TABLE 1, to thereby yield a conductive roller of Comparative Example 1.

The conductive elastic layers of Examples 1, 1a to 4, and Comparative Example 1 had compositional proportions shown in TABLE 1.

TABLE 1

| | Comp. | | | | | |
|---|---|---|---|---|---|---|
| | Ex. 1 | Ex. 1a | Ex. 1 | Ex. 2 | Ex. 3 | Ex. 4 |
| NBR | 80 | 75 | 70 | 60 | 50 | 40 |
| ECO | 20 | 25 | 30 | 40 | 50 | 60 |
| Stearic acid | 0.5 | 0.5 | 0.5 | 0.5 | 0.5 | 0.5 |
| Zinc oxide | 5 | 5 | 5 | 5 | 5 | 5 |
| BHT | 0.8 | 0.8 | 0.8 | 0.8 | 0.8 | 0.8 |
| Seast GSO | 10 | 10 | 10 | 10 | 10 | 10 |
| MT Carbon | 10 | 10 | 10 | 10 | 10 | 10 |
| Peroxide | 5 | 5 | 5 | 5 | 5 | 5 |
| vulcanizing agent | | | | | | |

### Test Example 1

The hardness of each of the conductive elastic layers of Examples 1, 1a to 4, and Comparative Example 1 was measured by means of a micro-hardness meter (MD-1; product of Kobunshi Keiki Co., Ltd.). TABLE 2 shows the results.

### Test Example 2

Test pieces were obtained from each of the conductive elastic layers of Examples 1, 1a to 4, and Comparative Example 1. The compression set of the test piece was determined. The compression set was calculated from the change in dimension 30 minutes after release from 25% compression at 180° C. for 22 hours (see the following formula (2)):

(Thickness of test piece before test−thickness of the same test piece after the test)/(thickness of test piece before test−thickness of a spacer) (2)

### Test Example 3

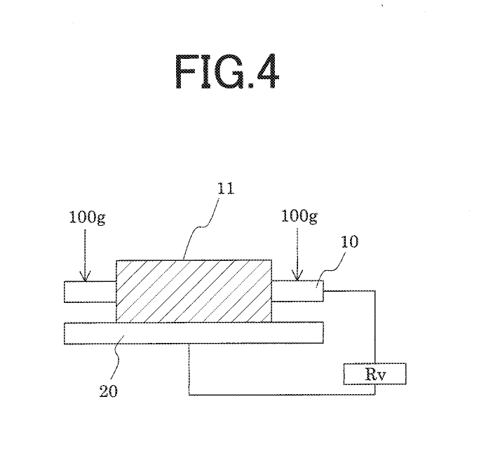

The electric resistance of each of the conductive elastic layers of Examples 1, 1a to 4, and Comparative Example 1 was measured. The electric resistance was measured by means of an apparatus shown in FIG. 4. Specifically, each of the conductive elastic layers of Examples 1, 1a to 4, and Comparative Example 1 was placed on an electrode member 20 made of a stainless steel (SUS 304) laminated sheet, and a load of 100 g was applied to both ends of the core 10. In this state, the electric resistance between the core 10 and the electrode member 20 was measured by means of ULTRA HIGH RESISTANCE METER R8340A (product of Advantest Corporation) under NN conditions (25° C., 50% RH).

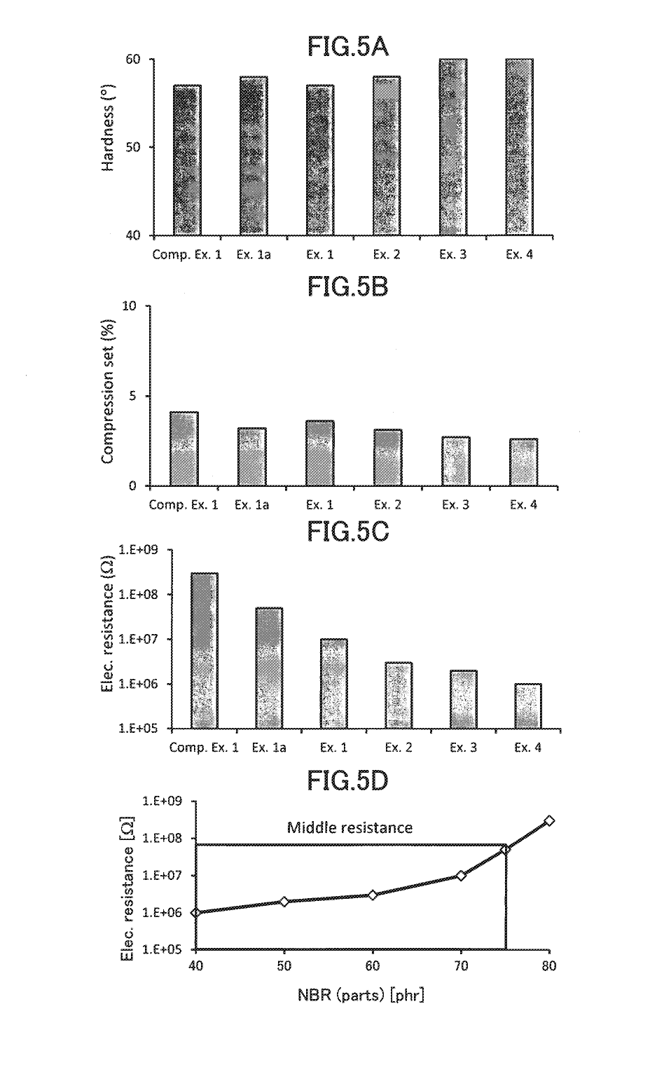

The results of Test Examples 1 to 3 re shown in TABLE 2 and FIG. 5.

TABLE 2

| | Comp. | | | | | |
|---|---|---|---|---|---|---|
| | Ex. 1 | Ex. 1a | Ex. 1 | Ex. 2 | Ex. 3 | Ex. 4 |
| Hardness [°] | 57 | 58 | 57 | 58 | 60 | 60 |
| Compression | 4.1 | 3.2 | 3.6 | 3.1 | 2.7 | 2.6 |
| set [%] | | | | | | |
| Elec. resistance | 3E+8 | 5E+7 | 1E+7 | 3E+6 | 2E+6 | 1E+6 |
| [Ω] | | | | | | |

Test Examples 1 to 3 have revealed that all the conductive rollers of Examples 1, and 1a to 4 have a moderate hardness (°) of each conductive elastic layer. Notably, NBR employed as a rubber base in Examples 1, and 1a to 4 has a price per kilogram about ½ that of ECO. Thus, the conductive rollers of Examples 1, and 1a to 4 are advantageous in terms of cost, as compared with the case of sole use of low-resistance polymer (NBR) as a rubber base.

Also, the conductive rollers of Examples 1, and 1a to 4 were found to have a sufficiently low compression set (%) of each conductive elastic layer. Thus, through vulcanizing any of the aforementioned rubber blend bases, having a ratio by mass of NBR to ECO falling within the specific range, with a peroxide vulcanizing agent, the produced conductive elastic layer was found to attain low compression set. In addition, as the NBR content of the rubber blend base decreased (i.e., the ECO increased), the compression set (%) of the conductive elastic layer was found to decrease.

However, the conductive roller of Comparative Example 1 was found to have elevated electric resistance of the conductive elastic layer. Such a conductive roller encounters difficulty in employment as, for example, a development roller of an image-forming apparatus. In contrast, all the conductive rollers of Examples 1, and 1a to 4 were found to have a target conductivity of the conductive elastic layer (i.e., the electric resistance was moderate; i.e., a level of middle resistance)). Such conductive rollers can be suitably used as, for example, a development roller of an image-forming apparatus. In addition, the rise in electric resistance was found to be more effectively suppressed in the conductive rollers of Examples 1, 2, 3, and 4, as compared with the conductive roller of Example 1a.

As used herein, the term “middle resistance” refers to, to a resistance falling within a region defined by the bold lines shown in FIG. 5D. That is, the middle resistance is about 1×10 to about 1×10⁸Ω. However, depending on the use and the like of the conductive roller, the lower limit of the middle resistance may be set to 1×10⁶Ω, and the upper limit thereof to 5×10⁷Ω.

As described above, Test Examples 1 to 3 have revealed that the conductive rollers of Examples 1, and 1a to 4 more effectively attain both a target conductivity and low compression set, as compared with the conductive roller of Comparative Example 1. In addition, material cost can be suppressed.

In the conductive rollers of Examples 1, and 1a to 4, electric resistance decreases with the ECO content, wherein ECO is more expensive but has lower resistance as compared with NBR. In other words, the electric resistance can be readily adjusted by tuning the ratio by mass of NBR to ECO. More specifically, the target electric resistance required for the conductive roller can be readily attained by tuning the ratio by mass of NBR to ECO. Thus, the conductive roller of the present invention has high adaptability to various uses.

### <Evaluation 2>

Characteristics of conductive rollers were assessed under varied peroxide vulcanizing agent contents.

### Examples 5 to 9

The procedure of Example 1 was repeated, except that the peroxide vulcanizing agent content was varied as shown in TABLE 3, to thereby yield conductive rollers of Examples 5 and 6. Also, the procedure of Example 1 was repeated, except that the type and mass ratio of the peroxide vulcanizing agent were varied as shown in TABLE 3, to thereby yield conductive rollers of Examples 7 to 9. In Examples 7 to 9, Perbutyl P-40 (product of NOF Corporation) was used as a peroxide vulcanizing agent.

The compositions of the conductive elastic layers of Examples 5 to 9 are shown in TABLE 3. In TABLE 3, the composition of the conductive elastic layer of Example 1 is also shown for reference.

TABLE 3

| | Ex. 5 | Ex. 1 | Ex. 6 | Ex. 7 | Ex. 8 | Ex. 9 |
|---|---|---|---|---|---|---|
| NBR | 70 | 70 | 70 | 70 | 70 | 70 |
| ECO | 30 | 30 | 30 | 30 | 30 | 30 |
| Stearic acid | 0.5 | 0.5 | 0.5 | 0.5 | 0.5 | 0.5 |
| Zinc oxide | 5 | 5 | 5 | 5 | 5 | 5 |
| BHT | 0.8 | 0.8 | 0.8 | 0.8 | 0.8 | 0.8 |
| Seast GSO | 10 | 10 | 10 | 10 | 10 | 10 |
| MT Carbon | 10 | 10 | 10 | 10 | 10 | 10 |
| Peroxide | 4 | 5 | 6 | — | — | — |
| vulcanizing agent | | | | | | |
| (Percumyl D-40) | | | | | | |
| Peroxide | — | — | — | 2 | 3 | 4 |
| vulcanizaing agent | | | | | | |
| (Perbutyl P-40) | | | | | | |

### Test Examples 4 to 6

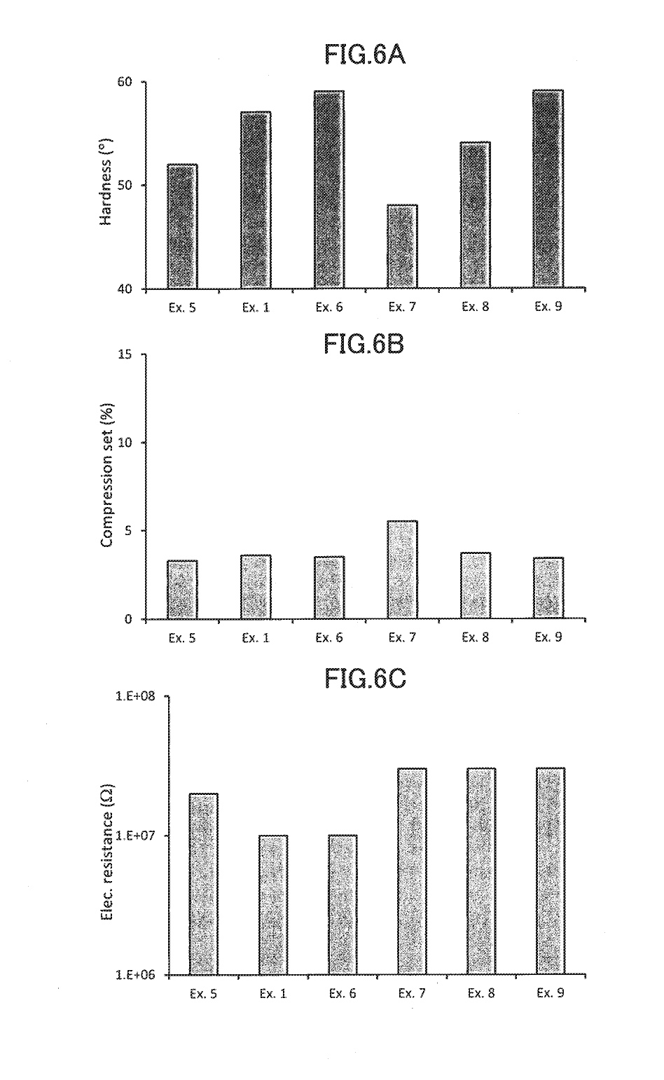

The hardness (°), compression set (%), and electric resistance (Ω) of the conductive elastic layers of Examples 5 to 9 were determined through the same techniques as employed in Test Examples 1 to 3. The results of Test Examples 4 to 6 are shown in TABLE 4 and FIG. 6. The test results of Example 1 are also shown in TABLE 4 and FIG. 6, for reference.

TABLE 4

| | Ex. 5 | Ex. 1 | Ex. 6 | Ex. 7 | Ex. 8 | Ex. 9 |
|---|---|---|---|---|---|---|
| Hardness [°] | 52 | 57 | 59 | 48 | 54 | 59 |
| Compression | 3.3 | 3.6 | 3.5 | 5.5 | 3.7 | 3.4 |
| set [%] | | | | | | |
| Elec. resistance | 2E+7 | 1E+7 | 1E+7 | 3E+7 | 3E+7 | 3E+7 |
| [Ω] | | | | | | |

Test Examples 4 to 6 have revealed that the hardness of each of the conductive rollers of Examples 5 to 9 increases, with the peroxide vulcanizing agent content. The hardness of the conductive elastic layer 11 can be readily modified by tuning the peroxide vulcanizing agent content. More specifically, the target hardness required for the conductive roller can be readily attained by tuning the peroxide vulcanizing agent content (e.g., 2 to 6 parts by mass, with respect to 100 parts by mass of the rubber blend base).

Also, in the conductive rollers of Examples 5 to 9, compression set was impaired, when the peroxide vulcanizing agent content was low. Particularly, in the case of Example 7, in which the peroxide vulcanizing agent content was small, compression set was sufficiently low, but it was higher than that obtained in the other Examples. In Example 7, vulcanization may be insufficient. In contrast, the conductive rollers of Examples 5, and 7 to 9, in which the peroxide vulcanizing agent content was 3 parts by mass (3 parts by mass with respect to 100 parts by mass of the rubber blend base) or higher, were found to be advantageous for realizing low compression set.

In addition, even when the type of the peroxide vulcanizing agent was altered, the conductive rollers of Examples 5 to 9 were found to have a target conductivity of the conductive elastic layer (i.e., the electric resistance was moderate; i.e., a level of middle resistance)). By use of an inexpensive peroxide vulcanizing agent, material cost can be advantageously reduced.

As described above, Test Examples 4 to 6 have revealed that the conductive rollers of Examples 5 to 9 more effectively attain both a target conductivity and low compression set, as compared with the conductive roller of Comparative Example 1. In addition, material cost can be suppressed.

### <Evaluation 3>

Characteristics of the conductive rollers obtained via a peroxide vulcanization system (the present invention) were compared with those obtained via a sulfur vulcanization system.

### Comparative Examples 2 and 3

The procedure of Example 1 was repeated, except that a sulfur-based (S) vulcanizing agent and a vulcanization accelerator were added instead of a peroxide vulcanizing agent, to thereby yield conductive rollers of Comparative Examples 2 and 3. In Comparative Examples 2 and 3, Actor R (product of Kawaguchi Chemical Industries, Co., Ltd.) was used as a vulcanizing agent, and Nocceler TS, TET, and CZ were used as vulcanization accelerators (products of Ouchi Shinko Chemical industrial Co., Ltd.).

The compositions of the conductive elastic layers of Comparative Examples 2 and 3 are shown in TABLE 5. In TABLE 5, the composition of the conductive elastic layer of Example 1 is also shown for reference.

TABLE 5

| | | Comp. | Comp. |
|---|---|---|---|
| | Ex. 1 | Ex. 2 | Ex. 3 |
| NBR | 70 | 70 | 70 |
| ECO | 30 | 30 | 30 |
| Stearic acid | 0.5 | 0.5 | 0.5 |
| Zinc oxide | 5 | 5 | 5 |
| BHT | 0.8 | 0.8 | 0.8 |
| Seast GSO | 10 | 10 | 10 |
| MT Carbon | 10 | 10 | 10 |
| Vulcanization accelerator (Nocceler TS) | — | 1.5 | 1.5 |
| Vulcanization accelerator (Nocceler TET) | — | 2 | 2 |
| Vulcanization accelerator (Nocceler CZ) | — | 2 | 2 |
| S vulcanizer (precipitated sulfur) | — | 0.5 | — |
| S vulcanizer (Actor R) | — | — | 1 |
| Peroxide vulcanizing agent | 5 | — | — |
| (Perbutyl P-40) | | | |

### Test Examples 7 to 9

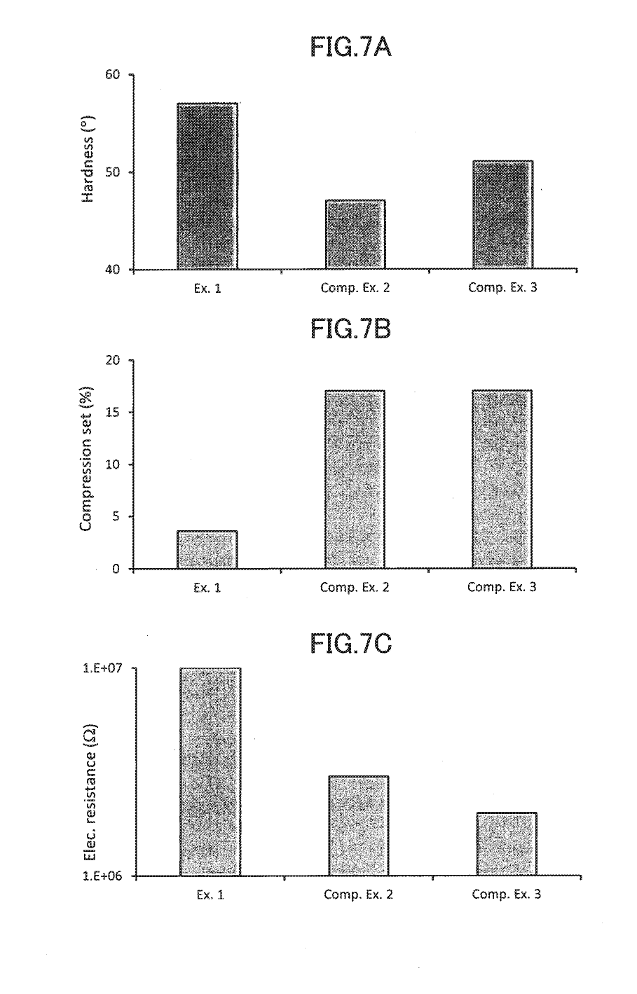

The hardness (°), compression set (%), and electric resistance (Ω) of the conductive elastic layers of Comparative Examples 2 and 3 were determined through the same techniques as employed in Test Examples 1 to 3. The results of Test Examples 7 to 9 are shown in TABLE 6 and FIG. 7. The test results of Example 1 are also shown in TABLE 6 and FIG. 7, for reference.

TABLE 6

| | | Comp. | Comp. |
|---|---|---|---|
| | Ex. 1 | Ex. 2 | Ex. 3 |
| Hardness [°] | 57 | 47 | 51 |
| Compression set [%] | 3.6 | 17 | 17 |
| Elec. resistance [Ω] | 1E+7 | 3E+6 | 2E+6 |

Test Examples 7 to 9 have revealed that, in the case of a sulfur-vulcanization system, hardness and electric resistance are reduced, but compression set is considerably impaired. The conductive roller of Example 1 exhibited a hardness and electric resistance higher than those of the conductive rollers of Comparative Examples 2 and 3. Such higher values are satisfactorily acceptable. However, the conductive rollers of Comparative Examples 2 and 3, exhibiting considerably high compression set, encounter difficulty in employment as, for example, a development roller of an image-forming apparatus.

### <Evaluation 4>

Characteristics of conductive rollers were assessed when NBRs having varied nitrile contents were used.

### Comparative Examples 4 to 6

The procedure of Example 1 was repeated, except that no low-nitrile type NBR was used, and the peroxide vulcanizing agent content was varied as shown in TABLE 7, to thereby yield conductive rollers of Comparative Examples 4 to 6. In Comparative Examples 4 to 6, Nipol DN2850 (product of Zeon Corporation) was used as NBR.

The compositions of the conductive elastic layers of Comparative Examples 4 to 6 are shown in TABLE 7. In TABLE 7, the composition of the conductive elastic layer of Example 1 is also shown for reference.

TABLE 7

| | | Comp. | Comp. | Comp. |
|---|---|---|---|---|
| | Ex. 1 | Ex. 4 | Ex. 5 | Ex. 6 |
| NBR (low nitrile-type) | 70 | — | — | — |
| NBR (medium nitrile-type) | — | 70 | — | — |
| NBR (medium nitrile-type) | — | — | 70 | — |
| NBR (medium nitrile-type) | — | — | — | 70 |
| ECO | 30 | 30 | 30 | 30 |
| Stearic acid | 0.5 | 0.5 | 0.5 | 0.5 |
| Zinc oxide | 5 | 5 | 5 | 5 |
| BHT | 0.8 | 0.8 | 0.8 | 0.8 |
| Seast GSO | 10 | 10 | 10 | 10 |
| MT Carbon | 10 | 10 | 10 | 10 |
| Peroxide vulcanizing agent | 5 | 5 | 6 | 7 |
| (Percumyl D-40) | | | | |

### Test Example 10

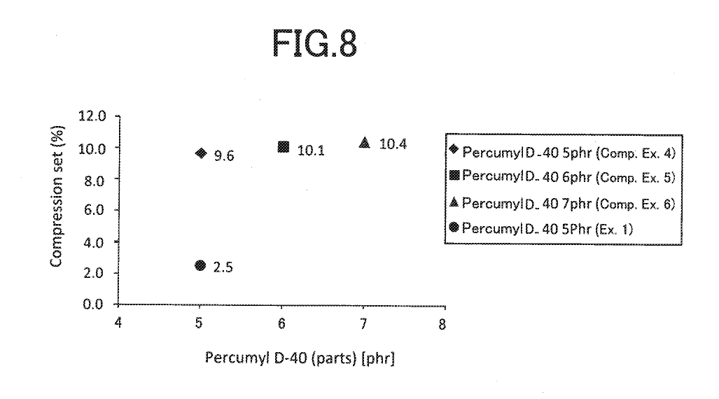

The compression set (%) of the conductive elastic layers of Comparative Examples 4 to 6 were determined through the same techniques as employed in Test Example 2. The results of Test Example 10 are shown in TABLE 8 and FIG. 8. The test results of Example 1 are also shown in TABLE 8 and FIG. 8, for reference.

TABLE 8

| | Ex. 1 | Comp. Ex. 4 | Comp. Ex. 5 | Comp. Ex. 6 |
|---|---|---|---|---|
| Compression set [%] | 2.5 | 9.6 | 10.1 | 10.4 |

Test Example 10 has revealed that low compression set can be attained only when NBR of a low-nitrile type having a low nitrile content and satisfying the aforementioned relationship (1) is used. Notably, even if NBR having an acrylonitrile content higher than that of NBRs employed in Comparative Examples 4 to 6 (e.g., high-nitrile type NBR) and satisfying the aforementioned relationship (1) is used, low compression set could not be conceivably attained.

### Other Embodiments

In the above, an embodiment of the present invention has been described in detail. However, the present invention should not be construed as to essentially limit to the aforementioned embodiment. Needless to say, the aforementioned conductive elastic layer may be formed of a plurality of layers, and another layer may intervene between the core and the conductive elastic layer.

Notably, in the drawings, essential elements in terms of properties (e.g., width and thickness of each layer, and the relative locations thereof) may be exaggerated in some cases.

What is claimed is:

1. A conductive roller having a core and a conductive elastic layer disposed on the core, wherein
the conductive elastic layer is formed of a vulcanized product of a rubber blend base containing a nitrile rubber (NBR) and an epichlorohydrin rubber (ECO) with a peroxide vulcanizing agent;
the NBR is a low-nitrile type rubber having an acrylonitrile content lower than 25 mass %; and
the ratio by mass of NBR to ECO, NBR:ECO, satisfies the following relationship (1):
40:60 to 75:25 (1).

2. A conductive roller according to claim 1, wherein the peroxide vulcanizing agent content is 2 to 6 parts by mass, with respect to 100 parts by mass of the rubber blend base.

3. A conductive roller according to claim 1, which is employed as a development roller of an image-forming apparatus.

4. A conductive roller according to claim 2, which is employed as a development roller of an image-forming apparatus.

5. A conductive roller according to claim 1, wherein the conductive elastic layer has a compression set of 3.7% or lower and an electrical resistance of 1×10⁶ to 5×10⁷Ω.

6. A conductive roller according to claim 2, wherein the conductive elastic layer has a compression set of 3.7% or lower and an electrical resistance of 1×10⁶ to 5×10⁷Ω.

7. A conductive roller according to claim 3, wherein the conductive elastic layer has a compression set of 3.7% or lower and an electrical resistance of 1×10⁶ to 5×10⁷Ω.

8. A conductive roller according to claim 4, wherein the conductive elastic layer has a compression set of 3.7% or lower and an electrical resistance of 1×10⁶ to 5×10⁷Ω.

9. A method for producing a conductive roller, which has a core and a conductive elastic layer disposed on the core, wherein the method comprising forming the conductive elastic layer by vulcanizing a rubber blend base containing a nitrile rubber (NBR) and an epichlorohydrin rubber (ECO) with a peroxide vulcanizing agent, the NBR being a low-nitrile type rubber having an acrylonitrile content lower than 25 masses, and the ratio by mass of NBR to ECO, NBR ECO, satisfying the following relationship (1)
40:60 to 75:25 (1).
